(19) United States
(12) Patent Application Publication
(10) Pub. No.: US 2022/0165187 A1
(43) Pub. Date: May 26, 2022

(54) VIDEO INFORMATION DISPLAY SYSTEM FOR A MOVING OBJECT

(71) Applicants: Olga Lvovna BAGAEVA, Krasnoyarsk (RU); Maksim Sergeevich BAGAEV, Krasnoyarsk (RU)

(72) Inventors: Olga Lvovna BAGAEVA, Krasnoyarsk (RU); Maksim Sergeevich BAGAEV, Krasnoyarsk (RU)

(21) Appl. No.: 17/600,448

(22) PCT Filed: Feb. 28, 2020
(86) PCT No.: PCT/RU2020/050031

§ 371 Date: Sep. 30, 2021

(30) Foreign Application Priority Data
Apr. 11, 2019 (RU) 2019110917

(51) Int. Cl. G09F 19/12; G09F 19/22

(52) U.S. Cl. CPC G09F 19/12; G09F 2019/221; G09F 19/226

(57) ABSTRACT

The invention relates to methods and devices for creating a system for exhibiting visual information to observers located in a moving vehicle, which system presupposes that a viewer is moving relative to any stationary systems displaying information. The movement of the viewer relative to these systems brings about mechanical scanning of an image, and a picture becomes complete for the viewer. The proposed system does not comprise any mechanical moving elements, and is highly reliable and resistant to any external influences (moisture, etc.). Modules do not comprise any moving parts and do not require regular maintenance. Synchronization is contactless, and the information delivered can be changed efficiently and remotely. Light-emitting diodes or semiconductor lasers or other means of generating light can be used as light-emitting elements.

### FIELD OF INVENTION

This invention belongs to the methods and devices for producing dynamic and static images for advertising and other purposes, for demonstrating amusement rides or other information.

### BACKGROUND

It is well known that the number of tunnels is increasing in developed countries and large cities. Therefore, using this invention enhances the advertising benefits by evoking passengers' interest, and sets claustrophobic passengers at rest (in case of long tunnels or mines).

There is a method for displaying visual information to viewers in a moving vehicle (Patent No. 2053574, IPC G09F21/04). In this method, information carriers are allocated in a systematized row along a vehicle's route. Each information carrier is illuminated and information is displayed to each viewer less than the time required for a vehicle to finish its route.

This method suffers from disadvantage of the pulses affecting retina as well as the difficulty of adjusting the display system=to passengers' movement speed.

There is an animation method for subway tunnels that uses general information or advertisements (Patent No. FR2539903, IPC G09F19/22, 1984-07-27). This method features the images (4) attached to a subway tunnel wall and illuminated by light spots (3). They are allocated outside of a train car and are lit for a short time by photoelectric cells (2) attached to the light spots (3) 4 2. The train speed of about 60 km/h is typical for animation as per claim 1 made by using subway tunnel walls for placing images (4) and mirrors (I) 3 with the animation as per claim 2. An image is illuminated every two meters by photocells.

The drawback of this engineering solution is the limited amount of received information due to very short time of displaying an image as the eyes require some time to adapt to a light spot, so the image cannot be quickly changed and dynamic images cannot be displayed at all.

There is an image display system for transport systems (Patent No. RF 71465, IPC G09F19/12). This system is composed of: a transport system; a vehicle that has at least one window and moves along a fixed route with practically constant speed V; an information carrier comprising multiple information elements installed one after another, on which the image frames are allocated to display successive phases of the object's movement; supports for attaching information carriers on one side of the fixed route along the transport system; and an illumination system. The illumination system is distinct in that each image has an actual image width and image center, while there is an interframe space between the image centers of successive information elements in the same row. The system has an actuation point located at a distance H from the first frame. Each information element is installed so that it can turn around the axis in the center of an image and has two extreme positions characterized by an angle between a frontal plane of an information element (on which a frame with an image is located) and by a vehicle's movement trajectory α. At that, α=10-55° for the first extreme position and α=0° for the second extreme position. An angular velocity with which an information element turns from the first extreme position to the second one is calculated depending on a window's width and a vehicle's average speed at a portion of the transport system with allocated information. 2. A system as per claim 1, wherein a vehicle is equipped with an illumination system to light the information elements, is synchronized with an image sequence and a vehicle speed. 3. A system as per claim 1, wherein an information carrier is equipped with an illumination system to light the information elements, is synchronized with an image sequence and a vehicle speed.

This engineering solution suffers from disadvantages as follows: difficulty in implementation, presence of moving parts, significant expenses for maintenance, dependence of an image quality on a viewer's movement speed, impossibility to change images quickly and to display dynamic images at all.

There is an advertising system for subway tunnels that has a display panel attached to the walls or roof of a tunnel and having a drum with the film wound on it. A passenger sees a moving image through a window (Patent GB No. 2272557, IPC G 09 F 19/22).

This engineering solution suffers from disadvantages as follows: transmitting information along a small portion of a route, difficulty in maintenance, impossibility to change images quickly and to display dynamic images at all.

A design closest to the presented invention is a device for demonstrating separate images, which comprises separate images put together along a path of a subway train or a city railroad train at a height of train windows so that it appears to a viewer as a moving image (Patent No. DE435148, IPC G09F19/22).

This design suffers from disadvantage of the pulses affecting retina, difficulty in maintenance, impossibility to change images quickly and to display dynamic images at all.

### SUMMARY

A technical aim of this invention is to develop a system for displaying visual information at a height of train windows to viewers in a moving vehicle. It is supposed that a viewer is moving relative to some stationary information display systems. Since a viewer moves relative to these systems, an image unfolds mechanically and a picture appears whole to a viewer.

A technical result of using this invention is that the presented system has no mechanical moving elements. It is highly reliable and resistant to external influences (moisture, etc.). Its linear array emitters have no moving parts and do not require regular maintenance. Synchronization does not require contact (with a train car), and, therefore, synchronization is more precise. The displayed information can be changed rapidly and remotely. Such change of information can be done very quickly. Dynamic images can be displayed. LEDs, semi-conducting lasers or other light generating means can be used as light-emitting elements.

This is achieved by creating a video information display system for a moving object in subway tunnels or transport system, a video information display system according to the invention has multiple linear array emitters positioned perpendicularly to a viewer's movement, these emitters form an image from a memory module by synchronizing a display speed and method with a viewer's movement speed relative to the emitters. Linear array emitters are attached to both sides of a route at equal distances from one another with an interval of, for example, 1 meter. A height of the linear array emitters and their arrangement ensure that a high-quality image is seen from the train windows, creating an illusion of a full coverage (for example, 1.5 meters or more). A number of illuminating elements in each linear array emitter depends on a throughput and a quality of a displayed video. The linear array emitters has a case, containing: a network module with an optical or other network interface connected to a microcontroller or microprocessor that controls the system; a module for synchronization with the train; a microcontroller/microprocessor for controlling a device that retrieves a video sequence from a RAM, transmitting it to a video sequence interpretation device (i.e. to the linear array emitter itself); RGB LEDs can be used for displaying to deliver full-color videos; a high-precision clock for synchronizing the system. At that, synchronization technology can be optical, laser, infrared beams (infrared laser), ultrasound or any central control. The system can display high-quality videos in full HD, 4K. To deliver a sufficient display quality and depth, a video information can be stored and processed with a resolution of 8 bit or more.

This invention has some significant differences from existing engineering solutions:

Compared with U.S. Pat. No. 2,053,574:

Depending on a viewer's movement speed, the system can regulate a speed and method of displaying information, thus providing high-quality images at any allowed speed.

Compared with Patent No. 71465:

1. Using this invention enhances the advertising benefits by evoking passengers' interest, and sets claustrophobic passengers at rest (in case of long tunnels or mines).
2. The difference of the presented invention is that the linear array emitters form any image on their own. There is no pre-installed image on the elements that display information.
3. The interval between the linear array emitters of this image is, for example, 1 meter.
4. Synchronization with a moving object is possible, but is not necessary.
5. The presented linear array emitters do not turn, since an image is projected perpendicularly to a viewer's movement.
6. Neither a vehicle nor linear array emitters are illuminated from the outside and they have no additional illumination systems.
7. A viewer (passenger) in a train car can completely perceive information from the very beginning of a trip through a tunnel, thanks to our invention.
8. Our modules have no moving parts and do not require regular maintenance.
9. It is possible to change a displayed information rapidly and remotely. Such change of information can be done very quickly.
10. To perceive information visually, adaptation or any other actions are not required from a passenger.

Compared with Patent DE No. 435148:

1. The presented invention has linear array emitters that project an image.
2. The pulse method is not used in this invention. The system is controlled remotely and allows reloading any information quickly. It is also possible to display dynamic images.

Compared with U.S. Pat. No. 2,272,557:

1. In the invention, linear array emitters project an image that gives a passenger the best possible illusion of being in some other place.
2. It is possible to install linear array emitters along the whole route, in any subway tunnels or in other locations.
3. The pulse method is not used in this invention. The system is controlled remotely and allows reloading any information quickly. It is also possible to display dynamic images.

### BRIEF DESCRIPTION OF THE DRAWINGS

The workings of the presented invention are explained in the drawings.

FIG. 1 schematically illustrates the video information display system for a moving object.

FIG. 2 is the same, a diagram of a linear array emitter.

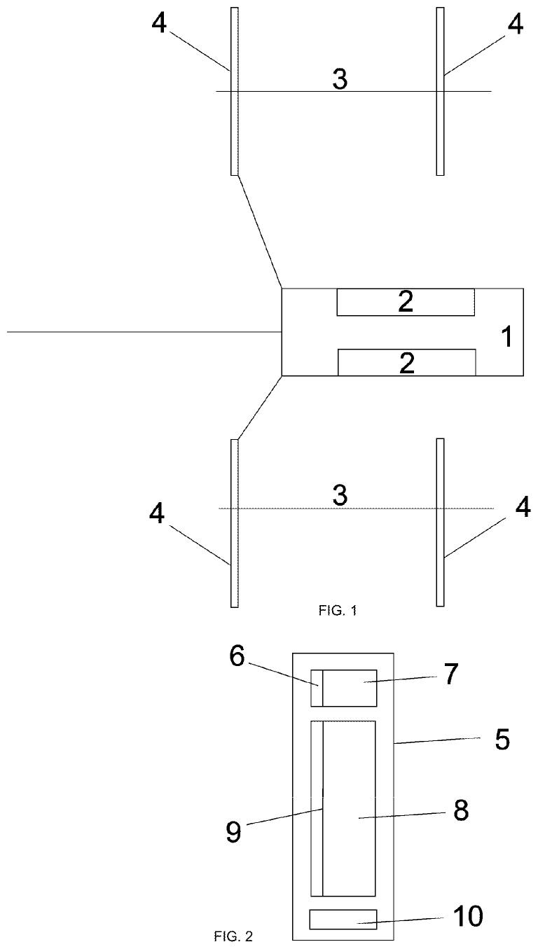

The markings stand for: an electric train car 1; a window 2 in the train car 1; a tunnel wall 3; linear array emitters 4; a case 5; a synchronization device 6; a control device 7 that may contain a microcontroller/microprocessor, a network module, a high-precision clock, a memory unit, that are not shown on the drawing; a LED interface 8; LEDs 9; a power supply unit 10.

### DETAILED DESCRIPTION OF THE PREFERRED EMBODIMENT

The device's description provides just one example of how this invention can be used. This invention can be designed in different ways.

The system has multiple linear array emitters positioned perpendicularly to a viewer's movement. These emitters form an image from a memory module, synchronizing a display speed and method with a viewer's movement speed relative to the emitters. The linear array emitters are attached to both sides of a tunnel at equal distances from one another with an interval of, for example, 1 meter. A height of the linear array emitters and their arrangement ensure that a high-quality image is seen from the train windows, creating an illusion of a full coverage (for example, 1.5 meters or more). A number of illuminating elements in each linear array emitter depends on a throughput and a quality of a displayed video;

The linear array emitters have a case 5; a synchronization device 6; a control device 7 that may contain a microcontroller/microprocessor, a network module, a high-precision clock, a memory unit (not shown in the Figure); a LED interface 8; LEDs 9; a power supply unit 10.

The network module is connected to a microcontroller or a microprocessor (not shown) which controls the system.

A device 6 for synchronization with a train. There are several ways of designing a synchronization of an image with a passing object. In some cases, a synchronization is not necessary at all. In the given example in a subway tunnel, a synchronization is not obligatory but advisable. Different synchronization methods can be used, such as: various illumination designs with measuring a movement speed, ultrasound, a high-frequency radiation in a radio wave spectrum, as well as other methods. A synchronization technology can be optical, laser, infrared beams (infrared laser), ultrasound or any central control. Different synchronization options are available. A synchronization can also be static. For example, in case of a motorway, all vehicles move with a fixed speed not less than a certain value, based on which an image can be displayed, without adjusting to or synchronizing with each particular viewer passing by, but adjusting to an average movement speed.

A microcontroller/mircroprocessor (not shown on the diagram) controls a device that chooses a video sequence from a RAM, which is then transmitted to a video sequence interpretation device (to the linear array emitter itself). A video sequence speed can vary widely depending on a speed of passing train cars.

It is most likely that RGB LEDs will be used for displaying to deliver full-colour videos (other ways of forming the image are also possible).

A high-precision clock for synchronizing modules.

To deliver a sufficient quality and depth of an image (dynamic range), a video information can be stored and processed with a resolution of 8 bit or more.

This invention suggests that a viewer moves relative to stationary display systems. Since a viewer moves relative to these systems, an image unfolds mechanically and apicture appears whole to a viewer.

The presented invention has a wide range of applications. The main areas being:

subway tunnels—any image or information is projected, and a viewer sees it from a train window. It can be designed as an underwater world or as anything else;
railroad transport—stations, tunnels. Used in a way similar to subways tunnels; vehicle roads:
a) installing emitters into a road that illuminate and project lines onto it, thus forming an image (for example, a laser projector above a road projects a line, and a viewer moving along a road sees an image displayed on the road;
b) motorroads with built-in elements for displaying information onto a surface, fences, structures for advertising or other purposes. A driver and passengers see the whole image as they move along;
c) installation along roads, a method similar to the installation in subway tunnels;
d) installation in tunnels.
e) amusement rides
f) elevator shafts, elevators.

As an example, one of the possible designs for this invention is described, i.e. installing the system in a subway tunnel.

The make-up of the system is described for one of possible designs for this invention—installing the system in a subway tunnel.

Vertical linear array emitters 4 with LEDs (not shown) are attached to both sides of a subway tunnel. The linear array emitters are allocated at equal distances from one another, for example, with an interval of 1 meter. A height of linear array emitters 4 and their arrangement ensure a high-quality view from subway train windows 2, thus creating an illusion of a full coverage, for example, 1.5 meters or more. A number of illuminating elements in each linear array emitter 4 depends on a throughput and a quality of a displayed video. It can display high-quality videos in full HD, 4K. Modern LEDs can provide a required quality of an image.

This description only pertains to simplified design versions of this invention. Many versions of this engineering solutions will be much more complex.

This is not the only possible design for the invention, other design versions are also possible. Specialists in this area can create other design versions staying within the scope of this technology. This design version shall not be seen as the only option of implementing this element of the technology and/or what has been described above shall not be the only way of implementing this element of the technology.

The make-up of this invention has no mechanical moving elements, it is highly reliable and resistant to any external influences (moisture, etc.), i.e. the structure is protected from external influences.

1. The presented emitters have no moving parts and do not require regular maintenance;
2. Synchronization does not require contact with a train car, and, therefore, synchronization is more precise;
3. It is possible to change a displayed information rapidly and remotely, such change of information can be done very quickly;
4. LEDs, semi-conducting lasers or other light generating means can be used as light-emitting elements.
Performing the system work.

A passenger travels in a leading train car. Immediately after passing the first emitter by a leading train car of a moving vehicle, an image begins to be displayed. Since the passenger expects to see an image that is static relative to their position, the image in the window should be similar to that on a TV set. For example, if the Barcelona Aquarium with fish is depicted, one can expect that fish would be hanging in the window and moving slowly, not flashing past the passenger at a speed of 80 km/h. The image is formed accordingly, so that it is relative to the passenger and relatively static. And yet linear array emitters that move past the passenger move with a speed of ˜28 pieces per second, if they are allocated with an interval of 1 meter and the speed is 80 km/h. Currently, it is the maximum speed for subway trains at the Koltsevaya Line in Moscow. On other subway lines, an electric train may move with a lesser speed of 60 km/h. Nevertheless, it is still quite reasonable to position emitters with an interval of 1 meter. However, the system does not limit the choice of the interval and it is possible to choose any other interval that provides the required design characteristics.

For example:

As a passenger moves in a leading car, the first emitters flies by, drawing one image frame, a fish or something else appears. Then, the second emitters speeds by, displaying the second image frame, and so on; when the speed gets high enough, emitters can repeat image frames. That is, a frame display speed changes depending on a viewer's movement speed.

The system itself (since it is controlled remotely) allows reloading information quickly, thus having an unlimited volume of information display; it is also possible to display high-quality full-colour information. Moreover, it is possible to display official or other emergency notifications. The presented system can be used as an emergency alert system (for example, signs indicating where to go during evacuation). The system can also be used to display information on the walls for a train driver, so that he can see images indicating turns, speed control, etc. It is possible, for example, to display useful official information (such as information on accidents) on roads. The platform allows multiple applications. One more example of using it on a motorroad: the system can be installed at a turn of a road. If there is a traffic sign at the very beginning, then emitters can be installed along the entire turn to display a turn indicator (in the form of an arrow) at night or during the day (but at night it will be very noticeable). This can significantly increase road safety. In case of motorways, information can be projected on the road surface.

What is claimed is:

1. A video information display system for a moving object in subway tunnels or transport system, comprising image storage devices installed along a route of a subway train or a city railroad at a height of train windows, so that a viewer perceives an information in a form of a moving image; wherein the system has multiple linear array emitters directed perpendicularly to viewer's movement direction; these emitters form an image from a memory module, synchronizing a display rate and a display method with a viewer's movement speed relative to the emitters; the linear array emitters are fixed on both sides of the route at an equal distance from one another, a height of the linear array emitters and their arrangement ensuring that a high-quality image is seen from the train windows, creating an illusion of a full coverage; a number of illuminating elements in each linear array emitters depends on a throughput and a quality of a displayed video; the linear array emitters has a case, containing: a network module with an optical or other network interface connected to a microcontroller or microprocessor that controls the system; a module for synchronization with the train; a microcontroller/microprocessor for controlling a device that retrieves a video sequence from a RAM, transmitting it to a video sequence interpretation device (i.e. to the linear array emitters itself); RGB LEDs being used for displaying to deliver full-color videos; a high-precision clock for synchronizing the system; the system provides for interaction with the train passengers with the system in a game-like way via their means of communication.

2. The video information display system for the moving object according to claim 1, wherein the synchronization technology can be optical, laser, infrared beams (infrared laser), ultrasound or any central control.

3. The video information display system for the moving object according to claim 1, wherein the system can display high-quality videos in full HD, 4K.

4. The video information display system for the moving object according to claim 1, wherein in order to deliver a sufficient display quality and depth, a video information can be stored and processed with a resolution of 8 bit or more.

5. The video information display system for the moving object according to claim 1, wherein a train synchronization module transmits information on a location of each subway train car to external systems in real time.

6. The video information display system for the moving object according to claim 1, further comprising an automatic calibration which significantly reduces a cost price.

7. The video information display system for the moving object according to claim 1, wherein the system creates an illusion of a another reality in a space around the moving train.
